(19) United States
(12) Patent Application Publication
(10) Pub. No.: US 2016/0377426 A1
(43) Pub. Date: Dec. 29, 2016

(54) DISTANCE DETECTION APPARATUS AND CAMERA MODULE INCLUDING THE SAME

(71) Applicant: SAMSUNG ELECTRO-MECHANICS CO., LTD., Suwon-si (KR)

(72) Inventor: Hyun KIM, Suwon-si (KR)

(73) Assignee: SAMSUNG ELECTRO-MECHANICS CO., LTD., Suwon-si (KR)

(21) Appl. No.: 14/994,652

(22) Filed: Jan. 13, 2016

(30) Foreign Application Priority Data
Jun. 24, 2015 (KR) 10-2015-0089938

(51) Int. Cl. G01C 3/08; H04N 5/378; H04N 9/04; H04N 5/04; H04N 5/235; H04N 5/225; H04N 5/376

(52) U.S. Cl. CPC G01C 3/08; H04N 5/2253; H04N 5/378; H04N 5/3765; H04N 5/04; H04N 5/2353; H04N 9/04

(57) ABSTRACT

A distance detection apparatus includes an image sensor including a first image sensor pixel array and a second image sensor pixel array each including pixels, and a synchronization unit synchronizing operations of the first image sensor pixel array and the second image sensor pixel array. In an example, the distance detection apparatus and the camera module precisely align optical axes of the two cameras without a manufacturing process error and accurately calculate distance information while reducing processing requirements.

### CROSS-REFERENCE TO RELATED APPLICATION(S)

This application claims the benefit under 35 USC 119(a) of Korean Patent Application No. 10-2015-0089938 filed on Jun. 24, 2015 in the Korean Intellectual Property Office, the entire disclosure of which is incorporated herein by reference for all purposes.

### BACKGROUND

1. Field

The following description relates to a distance detection apparatus. The following description also relates to a camera module including such a distance detection apparatus.

2. Description of Related Art

Recently, the market for mobile electronic computing devices such as mobile phones or tablet PCs has rapidly grown. An increase in an amount of pixels and size of available displays may be one technical aspect spurring rapid market growth. That is, the number of pixels of displays of mobile phones is tending to increase from QVGA (320×240) to VGA (640×480), WVGA (800×480), HD (1280×720), and to Full HD (1920×1080), or even greater resolutions. For example, the number of pixels is advancing to include WQHD (2560×1440) and UHD (3840×2160) resolutions, and even greater resolutions are possible in the future. Displays of mobile phones are also increasing in size from a diagonal size of 3″ to 4″, 5″, and to 6″ or even greater in size. As a display increases in size, the classification of a mobile device changes from a smartphone, which is generally highly portable and held in a single user's hand, to a phablet which is a device that is a smartphone that it is so large that it is almost a tablet, to an actual tablet that is larger than a smartphone and is used for slightly different purposes due to differences in portability and form factor.

As the amount of pixels of displays of smartphones increases, application techniques of image pickup camera modules attached to a front or rear surface of such smartphones have also been developed. Recently, high-pixel resolution autofocusing cameras are generally installed in smartphones. In addition, optical image stabilizer (OIS) cameras are increasingly employed in such smartphones. Also, recently, a function of digital single lens reflex (DSLR) cameras, in addition to a simple imaging function, has been gradually applied to smartphone cameras by providing optics and digital processing that yield improved quality images. A typical technique used in such cameras is a phase detection autofocusing (PDAF) technique capable of performing autofocusing at high speeds.

A high-speed autofocusing technique is classified as passive or active. A passive scheme recognizes a focus movement position of a lens by interpreting a captured image. An active scheme recognizes a focus movement position of a lens by directly sensing a distance to a subject using an infrared light source. In addition, smartphone cameras have started to adopt a scheme of directly sensing a distance to a subject through triangulation from images captured using two cameras at specific locations.

When a distance to a subject from the two cameras is detected individually by two cameras, a depth of field of a captured image is adjusted to a user desired value. That is, beyond the scheme of simply adjusting a depth of field by adjusting an iris, or an aperture or diaphragm, of an analog camera, presently, it is possible to realize a digital iris function using a digital image processing scheme using such information as discussed above.

However, in a stereoscopic camera scheme for detection of a distance, a space between two cameras and an optical axis of a counterpart camera in relation to a reference camera is required to be precisely aligned to achieve such an effect. If a space between the two cameras is different from a designed value, such as in an example in which optical axes of the two cameras are not aligned, calculated distance information may be inaccurate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An example potentially provides a distance detection apparatus for precisely aligning optical axes of two cameras without a manufacturing process error and also accurately calculates distance information. An example also provides a camera module including the distance detection apparatus.

In one general aspect, a distance detection apparatus includes an image sensor including a substrate, a first image sensor pixel array and a second image sensor pixel array spaced apart from one another on the substrate and aligned along an optical axis, each of the first image sensor pixel array and the second image sensor pixel array comprising pixels disposed in a matrix form, and a digital block configured to calculate information related to a distance to a subject using a signal output from the image sensor.

The substrate may be a silicon substrate.

The distance detection apparatus may further include an analog block configured to convert the signal output from the image sensor into a digital signal.

The analog block may include a sampling circuit configured to sample output signals from the first image sensor pixel array and the second image sensor pixel array, an amplifying circuit configured to amplify the sampled output signals sampled by the sampling circuit to produce an amplified sampled signal; and a digital conversion circuit configured to convert the amplified sampled signal into a digital signal.

The analog block may further include at least one of a phased lock loop (PLL) circuit configured to generate an internal clock signal upon receiving an external clock signal, a timing generator (T/G) circuit configured to control timing signals, and a read only memory (ROM) including firmware used for driving a sensor.

The digital block may synchronize output signals from the first image sensor pixel array and the second image sensor pixel array.

Outputs of photodiodes provided in a pair of mutually corresponding pixels among pixels of the first image sensor pixel array and pixels of the second image sensor pixel array may be read at the same point in time.

The digital block may synchronize operations of the first image sensor pixel array and the second image sensor pixel array.

The digital block may synchronize operations of a pair of mutually corresponding pixels among the pixels of the first image sensor pixel array and the pixels of the second image sensor pixel array.

The digital block may control exposure time points and exposure time durations of photodiodes provided in the pair of mutually corresponding pixels to be equal.

Each of the first image sensor pixel array and the second image sensor pixel array may be either a mono color pixel array or an RGB color pixel array.

In another general aspect, a camera module includes a sub-camera module including two lenses disposed to be spaced apart from one another and configured to calculate information regarding a distance to a subject, a main camera module including a lens and configured to capture an image of the subject, and a printed circuit board (PCB) on which the sub-camera module and the main camera module are mounted.

The PCB may include separate first and second PCBs, and the sub-camera module may be mounted on the first PCB and the main camera module may be mounted on the second PCB.

The sub-camera module and the main camera module may be mounted on the integrated PCB.

The main camera module may have a number of pixels greater than that of the sub-camera module.

Angles of view and focal lengths of the two lenses of the sub-camera module may be equal.

The angles of view of the two lenses of the sub-camera module may be greater than an angle of view of the lens of the main camera module.

Other features and aspects will be apparent from the following detailed description, the drawings, and the claims.

### BRIEF DESCRIPTION OF DRAWINGS

FIG. 1 is a block diagram of a distance detection apparatus according to an example.

FIG. 2 is a view illustrating a chip structure of a distance detection apparatus according to an example.

FIGS. 3A and 3B are views illustrating examples of a mono-color image signal.

FIGS. 4A and 4B are views illustrating examples of image signals in a YUV format;

FIG. 5 is a view illustrating a distance information map according to an example.

FIGS. 6A and 6B are views illustrating a configuration of a camera module according to an example.

FIGS. 7A and 7B are views illustrating a configuration of a camera module according to another example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, embodiments of the present inventive concept will be described as follows with reference to the attached drawings.

Throughout the specification, it is to be understood that when an element, such as a layer, region or wafer, such as a substrate, is referred to as being “on,” “connected to,” or “coupled to” another element, it is it possibly directly “on,” “connected to,” or “coupled to” the other element or alternatively other elements intervening therebetween are potentially present. In contrast, when an element is referred to as being “directly on,” “directly connected to,” or “directly coupled to” another element, there are no elements or layers intervening therebetween. Like numerals refer to like elements throughout. As used herein, the term “and/or” includes any and all combinations of one or more of the associated listed items.

It is intended to be apparent that though the terms first, second, third, etc. are used herein to describe various members, components, regions, layers and/or sections, these members, components, regions, layers and/or sections are not intended to be limited by these terms. These terms are only used to distinguish one member, component, region, layer or section from another region, layer or section. Thus, a first member, component, region, layer or section discussed below could be termed a second member, component, region, layer or section without departing from the teachings of the examples.

Spatially relative terms, such as “above,” “upper,” “below,” and “lower” and the like, are used herein for ease of description to describe one element's relationship to another element(s) as shown in the figures, such as relative position and structure. It is to be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. In other examples, the device is otherwise oriented, such as being rotated 90 degrees or at other orientations, and the spatially relative descriptors used herein are interpreted accordingly.

The terminology used herein is for describing particular examples only and is not intended to be limiting of the present inventive concept. As used herein, the singular forms “a,” “an,” and “the” are intended to include the plural forms as well, unless the context clearly indicates otherwise. It is to be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, examples are described with reference to schematic views illustrating the examples. In the drawings, for example, due to manufacturing techniques and/or tolerances, modifications of the shape shown are possibly estimated. Thus, examples are not to be construed as being limited to the particular shapes of regions shown herein, for example, to include a change in shape results in manufacturing. The following examples are also possibly constituted by one or a combination of explicitly discussed features and examples.

The contents of the present examples described below possibly have a variety of configurations and propose only a required configuration herein, but are not limited thereto.

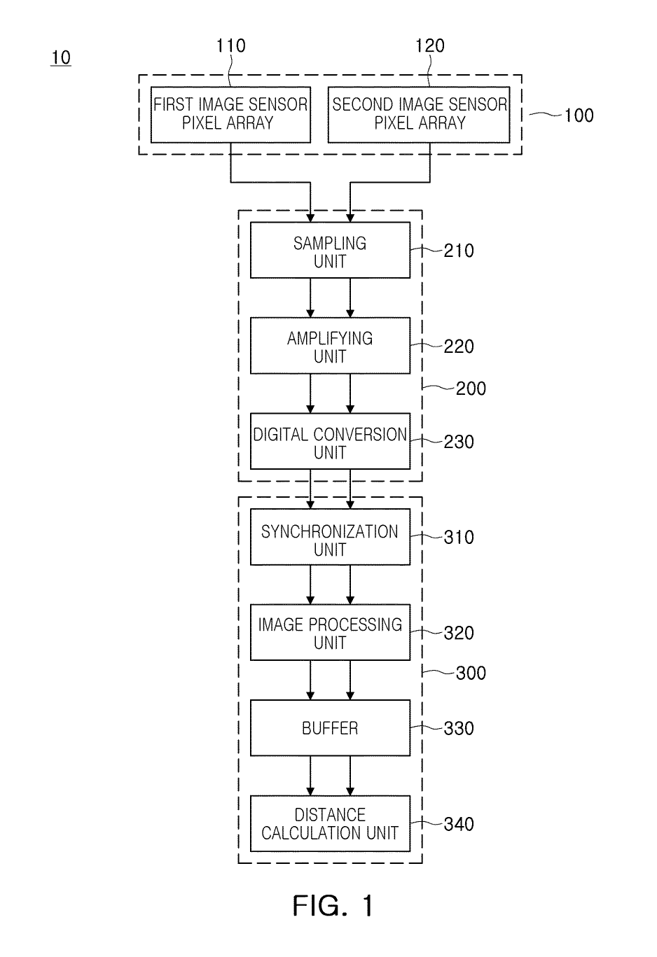

FIG. 1 is a block diagram of a distance detection apparatus according to an example.

A distance detection apparatus 10 according to the example of FIG. 1 includes an image sensor 100 and a digital block 300, and optionally further includes an analog block 200.

For example, the image sensor 100 includes at least one of image sensor pixel arrays 110 and 120. In further detail, in an example, the image sensor 100 includes a first image sensor pixel array 110 and a second image sensor pixel array 120.

In such an example, the first image sensor pixel array 110 and the second image sensor pixel array 120 are formed of one of a mono color pixel array in a black and white form and an RGB color pixel array in a red, green, and blue form. For example, the first image sensor pixel array 110 and the second image sensor pixel array 120 are formed on a substrate, and a lens is located on an upper surface thereof.

In an example in which the first image sensor pixel array 110 and the second image sensor pixel array 120 are mono color pixel arrays, each of the first image sensor pixel array 110 and the second image sensor pixel array 120 outputs a mono color image signal. Alternatively, in an example in which the first image sensor pixel array 110 and the second image sensor pixel array 120 are RGB color pixel arrays, the first image sensor pixel array 110 and the second image sensor pixel array 120 each output an image signal in a Bayer format. However, these are merely examples, and other formats of image signal are used in appropriately adapted examples.

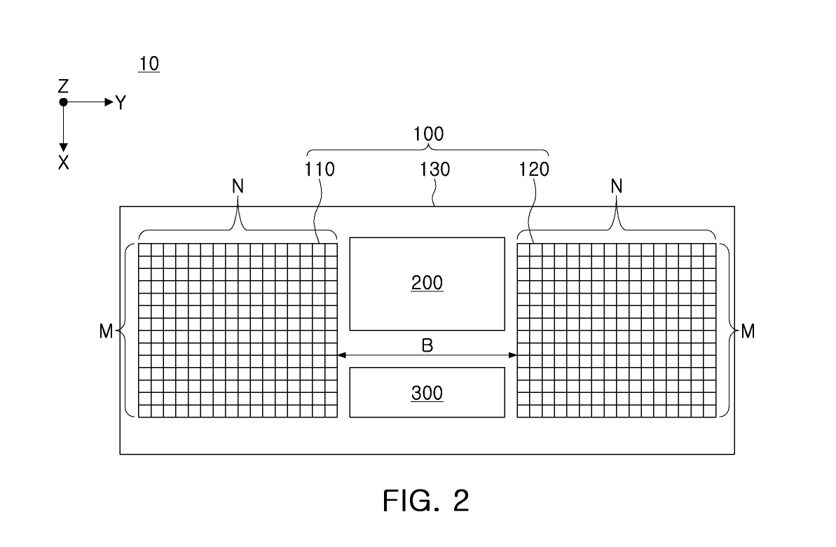

FIG. 2 is a view illustrating a chip structure of a distance detection apparatus according to an example.

The image sensor 100 according to an example includes a first image sensor pixel array 100, a second image sensor pixel array 120, and a substrate 130 on which the first image sensor pixel array 110 and the second image sensor pixel array 120 are formed.

For example, the first image sensor pixel array 110 and the second image sensor pixel array 120 each include a plurality of pixels in M, where M is a natural number that is 2 or greater, rows and N, where N is a natural number that is 2 or greater, columns disposed in a matrix form. For example, each of the plurality of pixels in the M×N matrix form has a photodiode.

The first image sensor pixel array 110 and the second image sensor pixel array 120 are located so as to be spaced apart from one another by a base line B on the substrate 130. In the example of FIG. 2, mutually corresponding pixels of the first image sensor pixel array 110 and the second image sensor pixel array 120 are located to be spaced apart from one another by the base line B. For example, pixels in a fourth row and fourth column of the first image sensor pixel array 100 and pixels in a fourth row and fourth column of the second image sensor pixel array are spaced apart from one another by the base line B.

An analog block 200 and a digital block 300 of the example of FIG. 1 are located between the first image sensor pixel array 110 and the second image sensor pixel array 120 and located at an outer region of the first image sensor pixel array 110 and the second image sensor pixel array 120 so as not to overlap with the first image sensor pixel array 110 and the second image sensor pixel array 120 on the substrate 130.

In an example, the substrate 130 on which the first image sensor pixel array 110 and the second image sensor pixel array 120 are located is a silicon substrate.

According to an example, the first image sensor pixel array 110 and the second image sensor pixel array 120 are manufactured through a semiconductor process technique using the same mask on the single silicon substrate 130. Thus, the first image sensor pixel array 110 and the second image sensor pixel array 120 are manufactured with a uniform base line for distances between mutually corresponding pixels of the first image sensor pixel array 110 and the second image sensor pixel array 120. As a result the first image sensor pixel array 110 and the second image sensor pixel array 120 are manufactured without a manufacturing process error in horizontal/vertical, or X axis and Y axis direction shift alignment and rotational alignment with respect to a Z axis from target design values. As a result of forming the pixel arrays in this manner, the images the pixel arrays generate correspond to each other in a known manner.

Also, since the first image sensor pixel array 110 and the second image sensor pixel array 120 of the image sensor 100 of the distance detection apparatus 10 according to an example are manufactured through a semiconductor process technique using the same mask on the single silicon substrate 130, a manufacturing process error is reduced. Accordingly, accurate distance information is calculated, as compared with the related art manufacturing method on a printed circuit board (PCB). Also, a process of calibrating a signal output from the image sensor 100 is omitted when comparing images from the pixel arrays during triangulating, effectively reducing a calculation load in the analog block 200 or the digital block 300 because of the omitted steps.

For example, the analog block 200 includes a sampling unit 210, an amplifying unit 220, and a digital conversion unit 230.

The sampling unit 210 samples output signals from the first image sensor pixel array 110 and the second image sensor pixel array 120. That is, the sampling unit 210 samples photodiode output voltages output from the first image sensor pixel array 110 and the second image sensor pixel array 120. For example, the sampling unit 210 has a correlated double sampling (CDS) circuit for sampling the photodiode output voltages output from the first image sensor pixel array 110 and the second image sensor pixel array 120.

The amplifying unit 220 amplifies the sampled photodiode output voltage from the sampling unit 210. To accomplish this goal, the amplifying unit 220 includes an amplifier circuit for amplifying the sampled photodiode output voltage from the sampling unit 210.

The digital conversion unit 230 includes an analog-to-digital converter (ADC) to convert the amplified photodiode output voltage from the amplifying unit 220 into a digital signal.

In addition, the analog block 200 optionally has a phase locked loop (PLL) circuit for generating an internal clock signal upon receiving an external clock signal. Another optional component of the analog block 200 is a timing generator (T/G) circuit for controlling various timing signals such as an exposure time timing, a reset timing, a line read timing, or a frame output timing of a photodiode of a pixel. The analog block 200 also optionally includes a read only memory (ROM) having firmware required for driving a sensor.

For example, the digital block 300 includes a synchronization unit 310, an image processing unit 320, a buffer 330, and a distance calculation unit 340.

The synchronization unit 310 controls the first image sensor pixel array 110 and the second image sensor pixel array 120 in order to calculate distance information with high accuracy. The synchronization unit 310 synchronizes operations of the first image sensor pixel array 110 and the second image sensor pixel array 120 and synchronizes output signals from the first image sensor pixel array 110 and the second image sensor pixel array 120.

Thus, the synchronization unit 310 controls exposure time points and time durations of photodiodes provided in a pair of mutually corresponding pixels among a plurality of pixels of the first image sensor pixel array 110 and a plurality of pixels of the second image sensor pixel array 120 so that they are equal. The synchronization unit 310 also reads outputs from the pair of mutually corresponding pixels at the same time point. Here, the pair of mutually corresponding pixels refers to a pair of pixels positioned in the same array positions in each matrix from among the plurality of pixels in a matrix form.

For example, the synchronization unit 310 controls exposure time points and time durations of a photodiode of a pixel in a fourth row and in a fourth column of the first image sensor pixel array 110 and a photodiode in a fourth row and in a fourth column of the second image sensor pixel array 120 to be equal, and reads an output from the photodiode of the pixel in the fourth row and the fourth column of the first image sensor pixel array 110 and an output from the photodiode of the pixel in the fourth row and fourth column of the second image sensor pixel array 120 at the same time point. Thus, because of the known difference in location between these corresponding pixels, the data produced by these pixels has a preexisting relationship that exists without a requirement for calibration.

In an example in which distance information of a moving subject is calculated using two pixel arrays such as the first image sensor pixel array 110 and the second image sensor pixel array 120, accuracy may be poor. However, the presence of the synchronization unit 310 according to an example allows for calculation of distance information with improved accuracy.

The image processing unit 320 processes a pixel image read from the synchronization unit 310.

In an example in which the first image sensor pixel array 110 and the second image sensor pixel array 120 of the image sensor 100 are mono color pixel arrays in a black and white form, the image processing unit 320 reduces noise of a mono color image signal. For example, various approaches for filtering the mono color image signal are used as appropriate to reduce the noise. In this example, the image processing unit 320 includes a single mono color signal processor to reduce noise of mono color image signals output from the first image sensor pixel array 110 and the second image sensor pixel array 120 together.

Also, in an example, the image processing unit 320 includes two mono color signal processors to separately reduce noise of the mono color image signals output from the first image sensor pixel array 110 and the second image sensor pixel array 120.

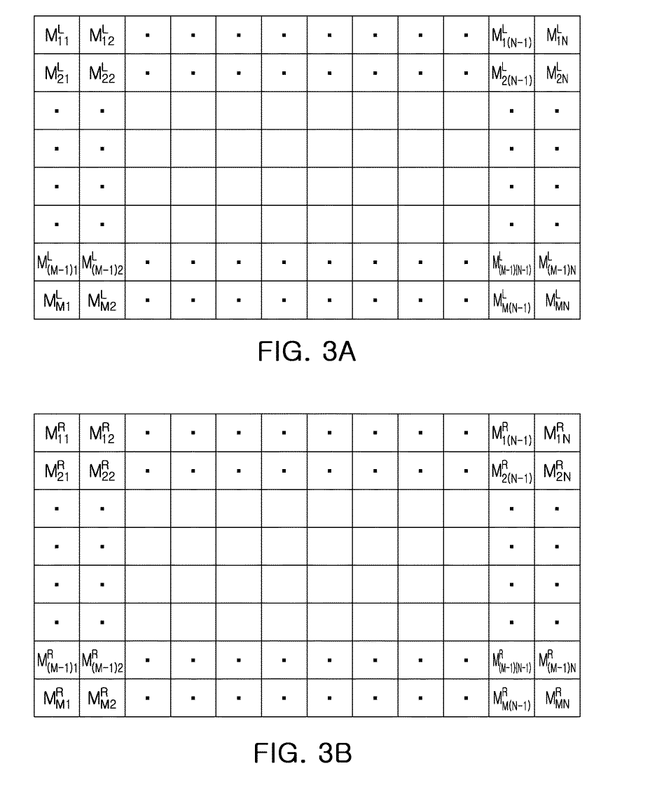

FIGS. 3A and 3B are views illustrating examples of a mono color image signal. The mono color image signals of FIGS. 3A and 3B are signals output from the synchronization unit 310 or a signal output from the image processing unit 320.

More specifically, FIG. 3A is a mono color image signal generated from a signal output from the first image sensor pixel array 110, and FIG. 3B is be a mono color image signal generated from a signal output from the second image sensor pixel array 120. Referring to the examples of FIGS. 3A and 3B, it is observable that image signals in a matrix form corresponding to the pixels in M row and N column of the first image sensor pixel array 110 and the second image sensor pixel array 120 are generated when the images are captured.

Referring back to the example of FIG. 2, in an example in which the first image sensor pixel array 110 and the second image sensor pixel array 120 of the image sensor 100 are RGB color pixel arrays, the image processing unit 320 interpolates image signals in a Bayer format output from the first image sensor pixel array 110 and the second image sensor pixel array 120 into image signals into an RGB format, and interpolates the image signals in the RGB format into image signals in a YUV format.

Here, in such an example, the image processing unit 320 includes a single Bayer signal processor and a single YUV processor to convert the Bayer format signals output from the first image sensor pixel array 110 and the second image sensor pixel array 120 into RGB format signals and to convert the RGB format signals into YUV format signals.

Also, in another example, the image processing unit 320 includes two Bayer signal processors and two YUV processors to separately convert the Bayer format signals output from the first image sensor pixel array 110 and the second image sensor pixel array 120 into RGB format signals and to separately convert the RGB format signals into YUV format signals.

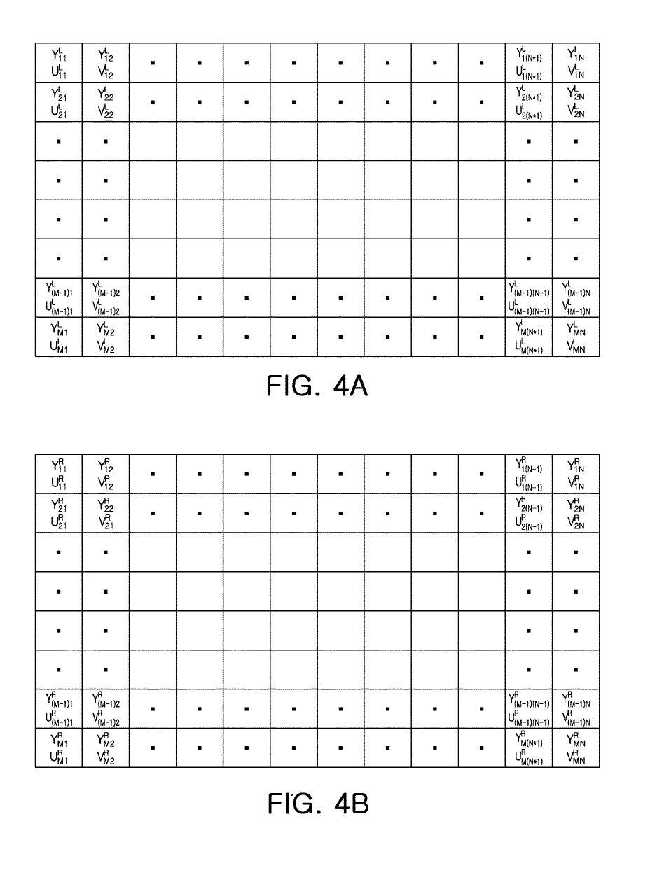

FIGS. 4A and 4B are views illustrating examples of image signals in a YUV format. The image signals in the YUV format of FIG. 4 are signals output from the image processing unit 320. More specifically, in an example, FIG. 4A is an image signal in a YUV format generated from a signal output from the first image sensor pixel array 110, and FIG. 4B is an image signal in a YUV format generated from a signal output from the second image sensor pixel array 120. Referring to FIGS. 4A and 4B, it is observable that image signals in a matrix form corresponding to M rows and N columns of the first image sensor pixel array 110 and the second image sensor pixel array 120 are generated.

In the example of FIG. 1, the buffer 330 receives the mono color signals or the image signals in the YUV format transferred from the image processing unit 320, and transmits the received mono color or YUV format color image signals to the distance calculation unit 340.

For example, the distance calculation unit 340 calculates a distance information map using brightness of the mono color or YUV format color image signals transmitted from the buffer 330. In the example of using the image sensor pixel array in M rows and N columns, the distance calculation unit 340 calculates a distance information map having resolution of M rows and N columns at the maximum.

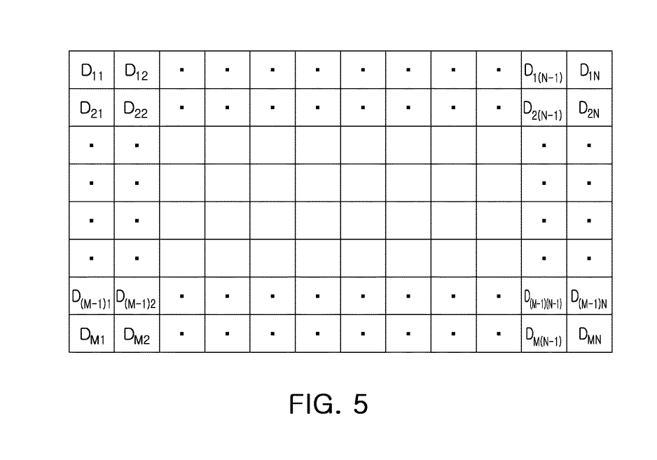

FIG. 5 is a view illustrating a distance information map according to an example. Referring to the example of FIG. 5, the distance calculation unit 340 calculates a distance information map in M rows and N columns by using brightness information of the mono color image signals illustrated in the example of FIGS. 3A and 3B, or may calculate a distance information map in M rows and N columns by using brightness information of the YUV format image signals illustrated in the example of FIGS. 4A and 4B.

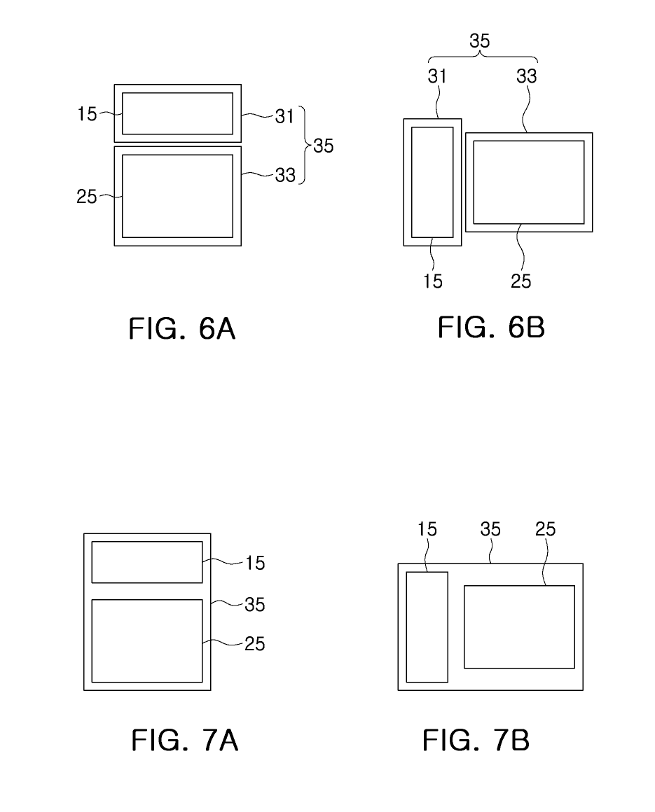

FIGS. 6A and 6B are views illustrating a configuration of a camera module according to an example.

Referring to the example of FIGS. 6A and 6B, the camera module according to an example includes a sub-camera module 15, a main camera module 25, and a printed circuit board 35 on which the sub-camera module 15 and the main camera module 25 are provided.

For example, the sub-camera module 15 calculates information regarding a distance to a subject. In such an example, the sub-camera module 15 includes the distance detection apparatus 10 according to the example of FIGS. 1 and 2, and further potentially includes two lenses respectively disposed on upper portions of the first image sensor pixel array 110 and the second image sensor pixel array 120 of the distance detection apparatus 10. The first image sensor pixel array 110 and the second image sensor pixel array 120 are situated to be spaced apart from one another as previously discussed. Thus, the two lenses are also provided to be spaced apart from one another in a corresponding manner.

In this example, angles of view or fields of view (FOV) and focal lengths of the two lenses of the sub-camera module 15 are provided to be equal. By situating the two lenses so as to have the same angles of view and the same focal lengths above the first image sensor pixel array 110 and the second image sensor pixel array 120, the same magnifications of a subject are obtained, and thus, an image processing operation that is required to be performed in a case in which magnifications are different is omitted. That is, according to the examples, since the angles of view and focal lengths of the two lenses are equal, distance information is easily and accurately detected and otherwise required processing is safely omitted.

For example, the sub-camera module 15 is one of a fixed focusing module or a variable focusing module.

Thus, the main camera module 25 captures an image of a subject. The main camera module 25 includes an image sensor having an RGB pixel array and a lens disposed on the image sensor. The main camera module 25 also optionally includes at least one of an autofocusing function and an optical image stabilizer (OIS) function. The main camera module 15 performs the autofocusing function or the OIS function by using the information regarding a distance to the subject detected by the sub-camera module 15. Such functions improve image quality by providing improved focusing and stabilizing the image, respectively.

In an example, the main camera module 25 has a number of pixels greater than that of the sub-camera module 15. The main camera module 25 in such an example also has at least one of the autofocusing function and the OIS function to aid in capturing an image of high pixel resolution and high image quality. The main camera module 25 also potentially uses these features to aid in recording video. Concurrently, the sub-camera module 15 is designed for calculating distance information at a high speed, and thus, the number of pixels of the main camera module 25 is possibly greater than that of the sub-camera module 15.

However, in an example, angles of view of the two lenses of the sub-camera module 15 are greater than that of a lens of the main camera module 25. As mentioned above, the main camera module 15 performs the autofocusing function and the OIS function using distance information of the subject detected by the sub-camera module 15. Hence, if angles of view of the two lenses of the sub-camera module 15 are less than that of the lens of the main camera module 25, an image region in which the main camera module 25 performs the autofocusing function or the OIS function is possibly limited by the angles of view of the lenses of the sub-camera module 15. Accordingly, angles of view are provided as discussed above.

According to an example, the angles of view of the two lenses of the sub-camera module 15 are greater than those of the lens of the main camera module 25, and thus, a subject imaging region of the sub-camera module 15 potentially sufficiently covers a subject imaging region of the main camera module 25.

Referring to the example of FIG. 6A, the sub-camera module 15 is located vertically above the main camera module 25, and referring to the example of FIG. 6B, the sub-cameral module 15 is located horizontally on the side of the main camera module 25.

Referring to the examples FIGS. 6A and 6B, the sub-camera module 15 and the main camera module 25 are separately mounted on a first PCB 31 and a second PCB 33, respectively. In an example in which the sub-camera module 15 and the main camera module 25 are located on different PCBs 31 and 33, respectively, when one of the two camera modules 15 and 25 is defective, the defective camera module is easily replaced and repaired separately.

FIGS. 7A and 7B are views illustrating a configuration of a camera module according to another example. The camera module of the examples of FIGS. 7A and 7B are similar to the camera module of the examples of FIGS. 6A and 6B. Thus, a repeated description thereof is omitted for brevity, and a difference between the examples is described.

Referring to the example of FIGS. 7A and 7B, the sub-camera module 15 and the main camera module 25 of the camera module are mounted on an integrated PCB 35, compared with the sub-camera module 15 and the main camera module 25 of the example of FIGS. 6A and 6B that are respectively mounted on the separate first and second PCBs 31 and 33. In such an example, in which the sub-camera module 15 and the main camera module 25 are directly mounted on the integrated PCB 35, the two camera modules 15 and 25 are situated to have the same height. Thus, distance information calculated by the distance detection apparatus of the sub-camera module 15 are reflected in the main camera module 25 without errors.

As set forth above in further detail, the distance detection apparatus and the camera module according to examples precisely align optical axes of the two cameras without causing manufacturing process errors, and accurately calculate distance information without a requirement for image processing to overcome errors that would otherwise be present.

The apparatuses, units, modules, devices, and other components illustrated in FIGS. 1-7B that perform the operations described herein with respect to FIGS. 1-7B are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-7B. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7B that perform the operations described herein with respect to FIGS. 1-7B are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A distance detection apparatus comprising:
an image sensor comprising a substrate, a first image sensor pixel array and a second image sensor pixel array spaced apart from one another on the substrate and aligned along an optical axis, each of the first image sensor pixel array and the second image sensor pixel array comprising pixels disposed in a matrix form; and
a digital block configured to calculate information related to a distance to a subject using a signal output from the image sensor.

2. The distance detection apparatus of claim 1, wherein the substrate is a silicon substrate.

3. The distance detection apparatus of claim 1, further comprising an analog block configured to convert the signal output from the image sensor into a digital signal.

4. The distance detection apparatus of claim 3, wherein the analog block comprises:
a sampling circuit configured to sample output signals from the first image sensor pixel array and the second image sensor pixel array;
an amplifying circuit configured to amplify the sampled output signals sampled by the sampling circuit to produce an amplified sampled signal; and
a digital conversion circuit configured to convert the amplified sampled signal into a digital signal.

5. The distance detection apparatus of claim 4, wherein the analog block further comprises at least one of:
a phased lock loop (PLL) circuit configured to generate an internal clock signal upon receiving an external clock signal;
a timing generator (T/G) circuit configured to control timing signals; and
a read only memory (ROM) comprising firmware used for driving a sensor.

6. The distance detection apparatus of claim 3, wherein the digital block synchronizes output signals from the first image sensor pixel array and the second image sensor pixel array.

7. The distance detection apparatus of claim 6, wherein outputs of photodiodes provided in a pair of mutually corresponding pixels among pixels of the first image sensor pixel array and pixels of the second image sensor pixel array are read at the same point in time.

8. The distance detection apparatus of claim 1, wherein the digital block synchronizes operations of the first image sensor pixel array and the second image sensor pixel array.

9. The distance detection apparatus of claim 8, wherein the digital block synchronizes operations of a pair of mutually corresponding pixels among the pixels of the first image sensor pixel array and the pixels of the second image sensor pixel array.

10. The distance detection apparatus of claim 9, wherein the digital block controls exposure time points and exposure time durations of photodiodes provided in the pair of mutually corresponding pixels to be equal.

11. The distance detection apparatus of claim 1, wherein each of the first image sensor pixel array and the second image sensor pixel array is either a mono color pixel array or an RGB color pixel array.

12. A camera module comprising:
a sub-camera module comprising two lenses disposed to be spaced apart from one another and configured to calculate information regarding a distance to a subject;
a main camera module comprising a lens and configured to capture an image of the subject; and
a printed circuit board (PCB) on which the sub-camera module and the main camera module are mounted.

13. The camera module of claim 12, wherein the PCB comprises separate first and second PCBs, and the sub-camera module is mounted on the first PCB and the main camera module is mounted on the second PCB.

14. The camera module of claim 12, wherein the sub-camera module and the main camera module are mounted on the integrated PCB.

15. The camera module of claim 12, wherein the main camera module has a number of pixels greater than that of the sub-camera module.

16. The camera module of claim 12, wherein angles of view and focal lengths of the two lenses of the sub-camera module are equal.

17. The camera module of claim 12, wherein the angles of view of the two lenses of the sub-camera module are greater than an angle of view of the lens of the main camera module.
